(19) United States
(12) Patent Application Publication
(10) Pub. No.: US 2025/0214731 A1
(43) Pub. Date: Jul. 3, 2025

(54) DRUG SUPPLY APPARATUS

(71) Applicant: PHC Holdings Corporation, Tokyo (JP)

(72) Inventor: Shiyouji SHIBATA, Ehime (JP)

(21) Appl. No.: 19/084,288

(22) Filed: Mar. 19, 2025

Related U.S. Application Data
(63) Continuation of application No. PCT/JP2023/034888, filed on Sep. 26, 2023.

(30) Foreign Application Priority Data
Oct. 28, 2022 (JP) 2022-173446

(51) Int. Cl. B65B 35/56; A61J 1/00; B65B 5/10

(52) U.S. Cl. CPC B65B 35/56; A61J 1/00; B65B 5/103

(57) ABSTRACT

A drug supply apparatus that packages a drug with packaging paper that is conveyed from an upstream side to a downstream side, the packaging paper being folded in half with an opening on an upper side, the drug supply apparatus including: a nozzle that dispenses the drug into the packaging paper, the packaging paper including a sealed part, in which the nozzle includes: an insertion guidance piece that protrudes downward and positions a folded part of a lower end of the packaging paper in a state of being inserted in the packaging paper from the opening on the upper side, and a posture adjustment part that guides to inside of the packaging paper the drug, and causes the drug to stand while shifting the drug toward the sealed part side in the packaging paper, the posture adjustment part being provided on the downstream side of the insertion guidance piece.

### CROSS-REFERENCE OF RELATED APPLICATIONS

This application is a Continuation of International Patent Application No. PCT/JP2023/034888, filed on Sep. 26, 2023, which in turn claims the benefit of Japanese Patent Application No. 2022-173446, filed on Oct. 28, 2022, the entire disclosure of which Applications are incorporated by reference herein.

### TECHNICAL FIELD

The present disclosure relates to a drug supply apparatus.

### BACKGROUND ART

Conventionally, a drug supply apparatus that packages and supplies a plurality of medicines one by one is known. For example, as disclosed in PTL 1, a drug supply apparatus appropriately ejects medicines (drugs) such as tablets and capsules ejected in a prescription (prescription data) from an ejection drum in a tablet case, collects the drugs in a hopper through a chute, and then packages (individually packages) the drugs in packaging paper for each package.

The drugs are packaged using a drug packaging apparatus arranged below the hopper. The drug packaging apparatus includes a nozzle that ejects the drug from a hopper. Below this nozzle, packaging paper with a V-shaped cross section, which has been pre-folded in half along the longitudinal direction, is conveyed. The drug is dispensed into the packaging paper through the nozzle and is sealed by heat welding.

The drug packaging apparatus dispenses the drug into the packaging paper that is sealed at a leading end part (downstream end part) by heat welding, and conveys the packaging paper to the downstream side by the length (conveyance pitch) of the width of one package for individual packaging. Next, the drug is packaged by sealing the terminal end part (upstream side end part) side and the upper side part in the packaging paper by heat welding.

In the packaging paper with the dispensed drug, the terminal end part sealed together with the upper side part by heat welding forms a welded part together with the leading end part which becomes the downstream end part of the package to which the drug is dispensed next. The drug packaging apparatus individually packages a plurality of drugs by dispensing drugs, conveying packaging paper, and performing the sealing by heat welding in a repetitive manner. Note that the packaging paper that accommodates the drug can be divided into individual packages at the welded part.

### CITATION LIST

### Patent Literature

PTL 1

Japanese Patent Application Laid-Open No. 2004-203433

### SUMMARY OF INVENTION

### Technical Problem

In a known drug supply apparatus, in a case where the size of the drug to be dispensed into the packaging paper is large, there is a possibility that the drug may be pushed to the upstream side within the packaging paper, and sandwiched in the welded part that is formed in the packaging of the packaging paper.

An object of the present disclosure is to provide a drug supply apparatus that prevents a drug from being sandwiched in a welded part in the packaging of the packaging paper.

### Solution to Problem

A drug supply apparatus according to the present disclosure packages a drug with packaging paper that is conveyed from an upstream side to a downstream side, the packaging paper being folded in half with an opening on an upper side, the drug supply apparatus including: a nozzle that dispenses the drug into the packaging paper, the packaging paper including a sealed part where the packaging paper is sealed on the downstream side, in which the nozzle includes: an insertion guidance piece that protrudes downward and positions a folded part of a lower end of the packaging paper in a state of being inserted in the packaging paper from the opening on the upper side, and a posture adjustment part that guides to inside of the packaging paper the drug to be dispensed, and causes the drug to stand while shifting the drug toward the sealed part side in the packaging paper, the posture adjustment part being provided on the downstream side of the insertion guidance piece.

### Advantageous Effects of Invention

According to the drug supply apparatus of the present disclosure, it is possible to prevent a drug from being sandwiched in a welded part in the packaging of the packaging paper.

### BRIEF DESCRIPTION OF DRAWINGS

FIG. 1 is a perspective view of a drug supply apparatus according to an embodiment of the present disclosure;

FIG. 2 is a longitudinal cross-sectional view of the drug supply apparatus;

FIG. 3 is a schematic view illustrating an overall configuration of a packaging unit of the drug supply apparatus;

FIG. 4 is an enlarged cross-sectional view illustrating a main part configuration of a filling unit;

FIG. 5 is a perspective view of a distal end part of a nozzle for describing a posture adjustment part; and

FIG. 6 is a perspective view schematically illustrating a main part configuration of a sealing device.

### DESCRIPTION OF EMBODIMENTS

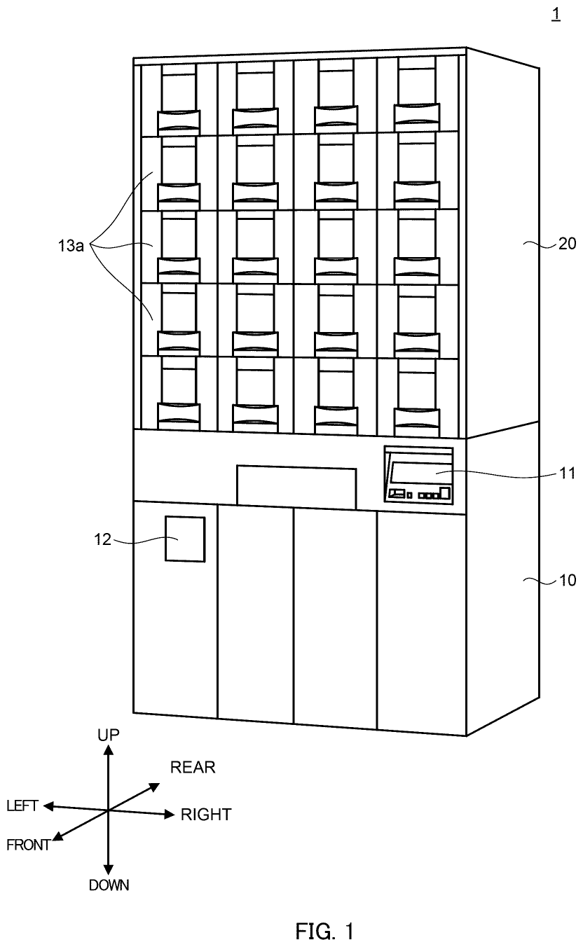

Hereinafter, an embodiment of a drug supply apparatus of the present disclosure will be described with reference to the drawings. In the following description, the side where operation part 11 is arranged is referred to as the front side of drug supply apparatus 1, and the opposite side is referred to as the back side of drug supply apparatus 1 as indicated by the arrows in FIG. 1. In addition, the left and right sides of drug supply apparatus 1 as viewed from the front side thereof are referred to as the left and right sides of drug supply apparatus 1, respectively. The side away from the surface on which drug supply apparatus 1 is installed is referred to as the upper side of drug supply apparatus 1, and the opposite side is referred to as the lower side of drug supply apparatus 1.

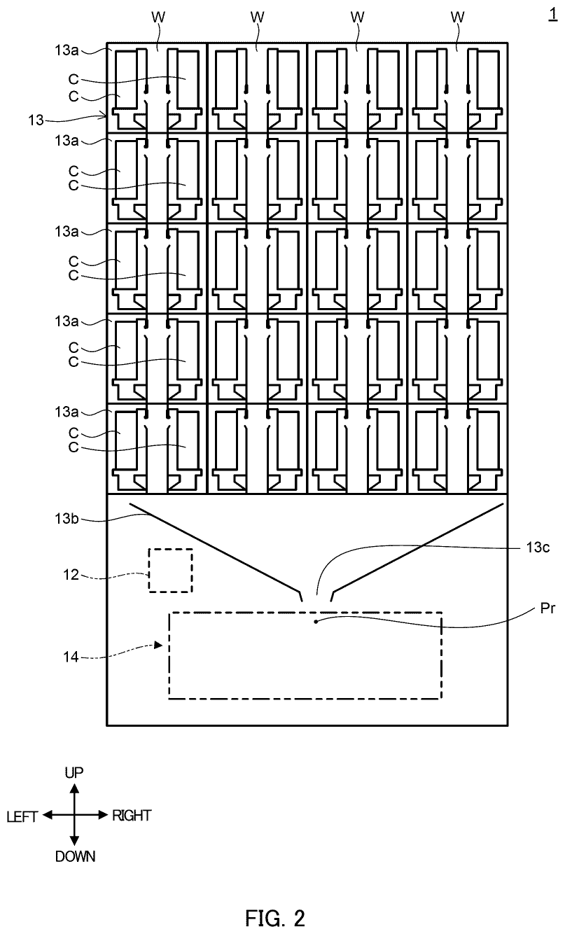

FIG. 1 is a perspective view illustrating an example of drug supply apparatus 1, and FIG. 2 is a longitudinal cross-sectional view of the drug supply apparatus. As illustrated in FIG. 1, drug supply apparatus 1 includes first floor part 10 and second floor part 20.

First floor part 10 includes operation part 11 and take-out part 12. In addition, first floor part 10 includes an input part (not illustrated).

Operation part 11 is a device to be operated by an operator, and includes, for example, a display, operation buttons, and the like. Various information is input to drug supply apparatus 1 as the operator operates operation part 11.

A drug packaged in drug supply apparatus 1 is taken out from take-out port 12. Take-out port 12 includes an opening, and the operator takes out the drug from the opening.

The input part is an input device to which various information input from an external device. The input part is connected to, for example, a personal computer, and information on a prescription issued by, for example, a medical institution is input from the personal computer.

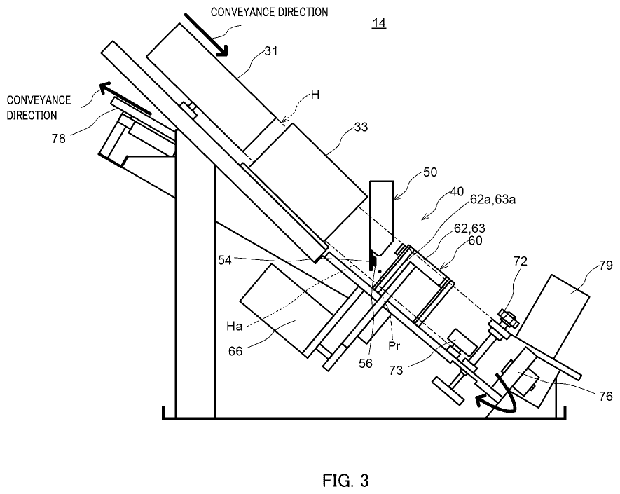

Further, as illustrated in FIG. 2, drug supply apparatus 1 includes drug supply unit 13, packaging unit 14, and a control part (not illustrated) that performs overall control of drug supply apparatus 1. Drug supply unit 13 is configured to supply a drug to drug delivery position Pr (see FIGS. 2 and 3). Drug supply unit 13 includes a plurality of shelves 13a and hopper 13b. First floor part 10 is arranged with packaging unit 14, and drug supply unit 13 is arranged across the upper part of first floor part 10 and second floor part 20.

The plurality of shelves 13a are each configured to store the plurality of cassettes C in the second floor part 20. Drug supply apparatus 1 includes 20 shelves 13a. The plurality of shelves 13a are arranged in five stages in the up-down direction and in four rows in the left-right direction. The number and arrangement of shelves 13a provided in second floor part 20 are not limited to those of the present embodiment, and the number of stages in the up-down direction and/or the number of rows in the left-right direction may be more or less than those described above.

A plurality of cassettes C are stored in each shelf 13a so as to be arranged in each shelf 13a along the front-rear direction on both sides of shelf 13a in the left-right direction. Each cassette C stores a plurality of drugs. Each cassette C is configured to eject one tablet of a drug at a time.

The drug ejected from cassette C falls through passage W and is ejected to first floor part 10. Passage W is provided so as to extend through each shelf 13a in the up-down direction.

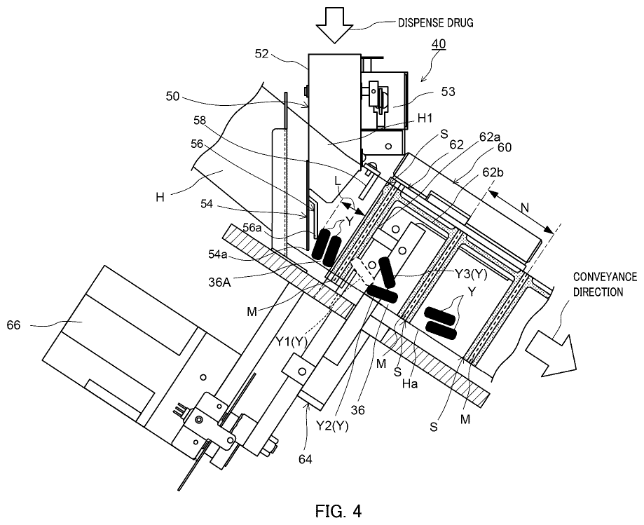

Hopper 13b receives the drug ejected to first floor part 10, and ejects the received drug to nozzle 50 (see FIG. 3) of packaging unit 14 from ejection port 13c. Upper opening H1 (see FIG. 4) of nozzle 50 is arranged directly below ejection port 13c.

FIG. 3 is a schematic diagram illustrating an overall configuration of a packaging unit of the drug supply apparatus.

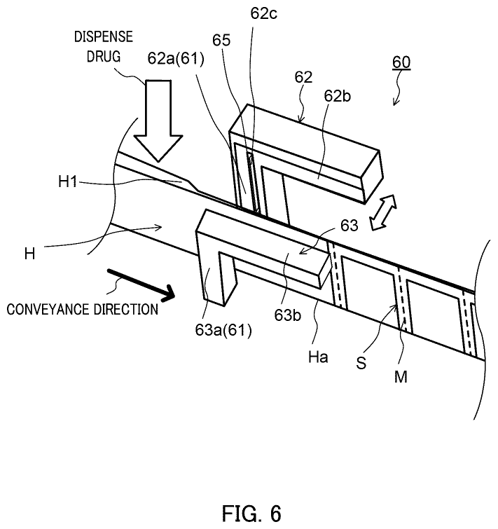

Packaging unit 14 packages the drug ejected from hopper 13b. The drugs are individually packaged in packaging paper H extending in the longitudinal direction to form package bags 36 (see FIGS. 4 and 6) whose width corresponds to the longitudinal direction of the packaging paper H.

Packaging unit 14 includes roll 31, printer 33, filling unit 40 (nozzle 50, sealing device 60), roller 72, cutter 76, conveyor 78, and motor 79.

Roll 31 is provided to be capable of winding and drawing out heat-weldable packaging paper H. Packaging paper H is a band-shaped member that extends in the longitudinal direction and is folded in half with the upper surface open. Packaging paper H has a substantially V-shaped cross section folded in half at the folded part at the lower end. Packaging paper H of roll 31 is drawn out toward printer 33 and filling unit 40 by the rotation driving of roller 72.

Note that, together with motor 73 that drives roller 72, conveyor 78, and motor 79 that drives conveyor 78, roller 72 constitutes a conveying part for accommodating and packaging the drug by conveying band-shaped packaging paper H.

Printer 33 is a printing machine that prints, for example, the patient's name, the name of the drug to be supplied, and the time of administration on the surface of packaging paper H conveyed by roller 72.

Filling unit 40 includes nozzle 50 that guides the drug from hopper 13b into packaging paper H, and sealing device 60 that seals the packaging paper in which the drug is packaged. In filling unit 40, the drugs are accommodated in packaging paper H, and the overlapping portions of packaging paper H in which the drugs are accommodated are sealed (a welded part is formed), thereby packaging the drugs into individual packages. The detail of such a configuration will be described later.

Cutter 76 cuts the welded part (which may also be referred to as a seal) of packaging paper H, or forms a cuttable cut line in a dashed line form in the welded part.

Conveyor 78, which conveys packaging paper H that is cut and divided into individual packages to take-out port 12, is continuously provided along the transport path of packaging paper H.

In packaging unit 14, packaging paper H is drawn out from roll 31 to the right diagonally downward by roller 72 or the like, and then printer 33 performs printing on its surface. Next, in filling unit 40, the drug is dispensed into packaging paper H from nozzle 50 and packaging paper H is partitioned and divided into individual packages by sealing device 60. Packaging paper H that is partitioned and divided is cut by cutter 76, and conveyed by conveyor 78 toward take-out port 12.

Conveyor 78 conveys divided packaging paper H from cutter 76 on the lower right side to take-out port 12 on the upper left side in FIG. 3.

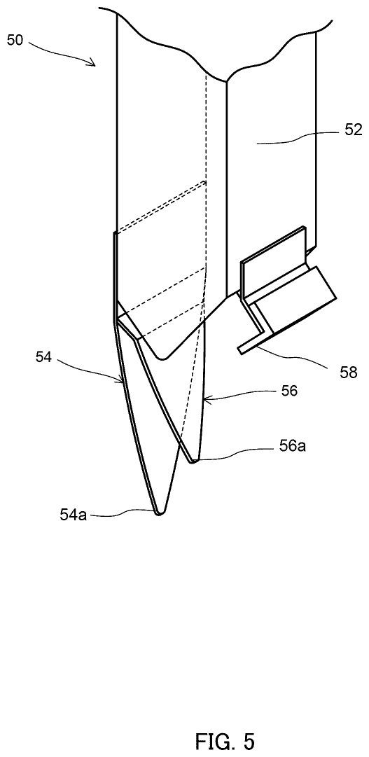

FIG. 4 is an enlarged cross-sectional view illustrating a main part configuration of the filling unit, and FIG. 5 is a perspective view of a distal end part of a nozzle for describing the posture adjustment part. Note that, since packaging paper H is translucent in FIG. 4, each part constituting filling unit 40 is schematically illustrated with a solid line for convenience. Further, the portion of packaging paper H illustrated with hatching in FIG. 4 is a welded part.

Nozzle 50 guides the drug from hopper 13b into packaging paper H and accommodates the drug in packaging paper H. Rectangular-tube shaped nozzle 50 with an opening in the up-down direction is arranged to extend, for example, in the vertical direction. The upper opening of nozzle 50 is located facing ejection port 13c of hopper 13b, and the drug received by hopper 13b enters nozzle 50 so as to be guided by insertion guidance piece 54 and dispensed into packaging paper H.

Nozzle 50 includes nozzle main body 52, shutter part 53, insertion guidance piece 54, and closing guidance piece 58.

Shutter part 53, provided on the upper part of nozzle main body 52, can freely open and close the opening of nozzle main body 52 to dispense the drugs to be accommodated in packaging paper H for each package.

Insertion guidance piece 54 is provided to protrude downward from the lower end part of nozzle main body 52 and is inserted into packaging paper H folded in half. Insertion guidance piece 54 protrudes in the vertical direction, which is the same direction as the extension direction of the nozzle, for example. Insertion guidance piece 54 has a shape whose thickness in the thickness direction of packaging paper H gradually decreases toward distal end part 54a. Insertion guidance piece 54 is inserted into packaging paper H from upper opening H1 of packaging paper H and holds packaging paper H in a V-shaped cross section.

Thus, insertion guidance piece 54 makes it easy to dispense the drug that falls from the inside of nozzle main body 52 into upper opening H1 by positioning the height position of folded part Ha at the lower end of packaging paper H folded in half at distal end part 54a, and holding packaging paper H opening upward.

Specifically, insertion guidance piece 54 is arranged to face welded part S of packaging H with a space therebetween, and is inserted into packaging paper H on the upstream side of welded part S in packaging paper H folded in half at folded part Ha, thereby opening the upper end of packaging paper H. Insertion guidance piece 54 is provided with posture adjustment part 56 protruding downstream. Posture adjustment part 56 adjusts the posture of the drug in packaging paper H.

In posture adjustment part 56, distal end part 56a is positioned at a higher position than folded part Ha in the vertical direction. Thus, posture adjustment part 56 comes into contact from the upstream side with drug Y dispensed in packaging paper H, and positions drug Y in a standing state with the drug shifted to the downstream welded part S side. Note that, as long as the drug dispensed in packaging paper H can be set to the standing state, distal end part 56a of posture adjustment part 56 may not be positioned at a position higher than folded part Ha in the vertical direction. Setting the drug to the standing state with the drug shifted to the downstream side of welded part S can prevent the drug from being sandwiched in welded part S when the drug is packaged with the packaging paper. For example, distal end part 56a of posture adjustment part 56 may be positioned to be spaced apart from distal end part 54a of insertion guidance piece 54 in a direction orthogonal to the conveyance direction with respect to packaging paper H that is conveyed in a manner inclined downward as it goes downstream. Further, distal end part 56a of posture adjustment part 56 may be arranged to be spaced apart from folded part Ha by the same length in a direction orthogonal to the conveyance direction together with distal end part 54a of insertion guidance piece 54. In this case, in a case where the conveyance direction is inclined to the downstream side, distal end part 56a of posture adjustment part 56 is positioned below distal end part 54a of insertion guidance piece 54.

For example, as illustrated in FIG. 4, posture adjustment part 56 is inclined at an angle of 90 degrees or less with respect to the horizontal plane so as to come into contact from the upstream side of drug Y and incline drug Y to the downstream side from the standing state in the vertical direction with the lower end part of the drug as the center. Since drug Y is dispensed into packaging paper H, posture adjustment part 56 positions the lower end part of drug Y at a position closest to folded part Ha of packaging paper H such that the upper end part is positioned is located on the downstream side in the conveyance direction with respect to the vertical direction. Thus, even when packaging paper H with the dispensed drug is conveyed downstream and is set at the position where welded part S is to be formed by vertical seal part 61, the drug is not located at that position.

The position of distal end part 56a of posture adjustment part 56 is set according to the shape of the drug to be dispensed into packaging paper H and the size of the region into which the drug is dispensed in packaging paper H.

For the packaging with packaging paper H, it is preferable that the size of the drug to be dispensed into packaging paper H is a size of a drug that is versatile and relatively large in dimensions, and it is assumed that a plurality (two) of drugs of that size are dispensed. For example, a length L of packaging paper H along the extension direction from distal end part 56a of posture adjustment part 56 to welded part S is preferably 13.2 mm to 17.2 mm or more. The length L is more preferably 14.2 mm to 16.2 mm or more, and even more preferably 15.2 mm (the width for accommodating two No. 0 capsules) or more. Posture adjustment part 56 is preferably arranged at a position where the above-described length L is a distance with which at least two No. 0 capsule drugs can be dispensed. Even when one or more drugs smaller than this size are dispensed, the drugs are not set at the sealing position in a state of being conveyed to sealing device 60. Note that, even in a case where a plurality of capsules of Nos. 00 and 000 are dispensed, the capsules may be shifted to the downstream side, that is, the welded part S side, and inclined to the downstream side such that packaging can be suitably performed by sealing the end part on the upstream side with sealing device 60.

Note that, even in a case where a drug having a dimension smaller than 15.2 mm is dispensed into packaging paper H and is conveyed to the sealing device, drug Y is not positioned in a portion (welded part S) that is welded by vertical parts 62a and 63a (see FIG. 6) of vertical seal part 61, as indicated by drug Y3 overlapping drug Y2.

Further, posture adjustment part 56 is configured to protrude from insertion guidance piece 54, but this is not limitative, and it may be formed integrally with insertion guidance piece 54 by forming distal end part 56a by processing a part of insertion guidance piece 54 to protrude to the downstream side. Further, posture adjustment part 56 may be detachably attached to insertion guidance piece 54. In a case where posture adjustment part 56 is provided integrally with insertion guidance piece 54, the number of components can be reduced, and drug supply apparatus 1 can be more easily assembled. Further, in a case where posture adjustment part 56 is detachably attached to insertion guidance piece 54, posture adjustment part 56 can be changed according to the size of the drug, the number of drugs, the conveyance speed, and the like, and the packaging can be performed suitably for each case.

Thus, the drug is accommodated in packaging paper H such that it is sandwiched in the half-fold portion near folded part Ha, which is the lower end of packaging paper H, and brought into contact with distal end part 56a, in a posture inclined to the downstream side, not to the upstream side.

Posture adjustment part 56 defines the length of folded part Ha along the longitudinal direction of packaging paper H from the lower end part (the end part on the folded part Ha side) of welded part S in packaging paper H, and constitutes a substantially triangular bag portion together with one side of welded part S, thereby forming small bag 36A that accommodates the drug to be dispensed.

Closing guidance piece 58, which is arranged to face insertion guidance piece 54, has a function of closing upper opening H1 of packaging paper H. Closing guidance piece 58 closes opening H1 of packaging paper H by sandwiching the upper end part of packaging paper H that is opened by the insertion of insertion guidance piece 54 with the drug dispensed inside.

Sealing device 60 is a device that seals packaging paper in which a drug is wrapped. Sealing device 60 partitions and divides packaging paper H into individual packages by heat welding with heater block 62. Note that, packaging paper H divided into individual packages is then cut at a predetermined timing by cutter 76 and is conveyed toward take-out port 12 by conveyor 78.

Sealing device 60 is arranged adjacent to nozzle 50 on the downstream side in the conveyance direction, and has a function of sealing upper opening H1 of packaging paper H by heat welding and partitioning the packaging paper into each package.

As illustrated in FIG. 6, sealing device 60 includes heater block 62 and pressure receiving block 63 that are provided to face each other with a predetermined distance therebetween. Heater block 62 is provided with actuator 64 (see FIG. 4) including motor 66. This actuator 64 is configured to press or separate heater block 62 against or from pressure receiving block 63 facing each other by driving motor 66. Pressure receiving block 63 is configured to make pressure contact with heater block 62 and sandwich the packaging paper between pressure receiving block 63 and heater block 62. By energizing heater block 62, heater block 62 generates heat at a predetermined temperature, and heats and welds the packaging paper sandwiched between heater block 62 and pressure receiving block 63.

Heater block 62 and pressure receiving block 63 are composed of vertical parts 62a and 63a and parallel parts 62b and 63b, respectively. Vertical parts 62a and 63a are provided to extend in the up-down direction (referred to as the transverse direction of packaging paper H, and also referred to as the width direction of packaging paper H) in FIG. 6. Parallel parts 62b and 63b are provided to extend from the upper end parts of vertical parts 62a and 63a to the downstream side in the feeding direction of packaging paper H (the longitudinal direction of packaging paper H).

As illustrated in FIGS. 4 and 6, heater block 62 and pressure receiving block 63 have an inverted L-shape. Vertical parts 62a and 63a of heater block 62 and pressure receiving block 63 constitute vertical seal part 61. Vertical parts 62a and 63a form welded part S by sandwiching from both sides packaging paper H conveyed and heat-welding it from folded part Ha side to upper opening H1 of packaging paper H.

Welded part S, provided to extend in a direction orthogonal to the conveyance direction, fixes the downstream end part of packaging paper H in a direction orthogonal to the conveyance direction. Welded part S serves as a reference for the arrangement position of posture adjustment part 56. Thus, a substantially triangular bag portion (small bag 36A) surrounded by welded part S and folded part Ha in a state in which upper opening H1 is not welded is formed on the upstream side of sealing device 60 in packaging paper H. The drug is dispensed into this bag portion (small bag 36A) from nozzle 50 as described above. Further, parallel parts 62b and 63b perform heat-welding on upper opening H1 of packaging paper H on the downstream side of vertical parts 62a and 63a.

Packaging paper H heat-welded by sealing device 60 is conveyed further downstream at a predetermined pitch by the rotation of roller 72. The predetermined pitch is, for example, a pitch from the position where the drug is dispensed into packaging paper H to the position where the welded part is formed, or in other words, a length in the extending direction of packaging paper H, which is the width N of the package bag formed by the packaging.

By heat-welding packaging paper H, heater block 62 and pressure receiving block 63 form package bag 36 (see FIG. 4) which is heat-welded at parts other than folded part Ha and in which a drug is sealed on the downstream side (pull-in roller 72 side) of vertical parts 62a and 63a of heater block 62 and pressure receiving block 63. Simultaneously, heater block 62 and pressure receiving block 63 form small bag 36A (see FIG. 4) on the upstream side of vertical parts 62a and 63a.

Further, a vertical tooth (not illustrated) extending in the up-down direction is built in vertical part 63a of pressure receiving block 63. On the other hand, vertical part 62a of heater block 62 is provided with vertical tooth receiving part 62c that receives a vertical tooth (not illustrated) in a portion corresponding to the vertical tooth (not illustrated).

Note that, the vertical tooth and vertical tooth receiving part 62c are formed to have a length from the lower end part to a portion where the upper end is left in the up-down direction of packaging paper H. Thus, when heat welding is performed from folded part Ha of packaging paper H to upper opening H1, the vertical tooth and vertical tooth receiving part 62c form a perforation (perforation-like hole) at the substantially center of the width of the welded part (from folded part Ha to the edge part of upper opening H1).

Package bag 36 is heat-welded on three sides (the remaining side is folded part Ha), and the entire periphery is closed. Further, package bag 36 is configured to be separable from another package bag 36 by cutting the perforation. Note that, gap part 65 is provided around the vertical tooth (or vertical tooth receiving part 62c) in vertical seal part 61 of pressure receiving block 63 and heater block 62. With this gap, the periphery of the perforation formed by the vertical tooth and vertical tooth receiving part 62c is not welded in packaging paper H.

According to drug supply apparatus 1 of the embodiment of the present invention, even in a case where a plurality of drugs are dispensed into packaging paper H and are individually packaged, the drugs are arranged on the downstream side in the conveyance direction in packaging paper H without being inclined to the upstream side in the conveyance direction on the welded part side, which is a side portion on the downstream side in the conveyance direction. Thus, the drug accommodated in packaging paper H is not located at a position (the welding portion forming position; the position sandwiched by vertical seal part 61) to be welded when welding the upstream side end part. Thus, when packaging is performed by welding in a sealing manner with the drug accommodated inside packaging paper H, the drug can be suitably packaged without being sandwiched in the welding device.

According to drug supply apparatus 1, with posture adjustment part 56, it is possible to prevent the drug dispensed into packaging paper H from moving to the upstream side so as to be sandwiched in a welded part formed by heat welding in packaging paper H even in a case where the size of the drug to be dispensed into the packaging paper is large. As a result, drug supply apparatus 1 according to the present embodiment can accommodate a plurality of drugs regardless of the size and supply drugs that are suitably packaged one by one.

The disclosure of Japanese Patent Application No. 2022-173446, filed on Oct. 28, 2022, including the specification, claims, drawings, and abstract, is incorporated herein by reference in its entirety.

### INDUSTRIAL APPLICABILITY

The present disclosure is widely applicable to drug supply apparatuses.

### REFERENCE SIGNS LIST

1 Drug supply apparatus
10 First floor part
11 Operation part
12 Take-out port
13 Drug supply unit
13a Shelf
13b Hopper
13c Ejection port
14 Packaging unit
20 Second floor part
31 Roll
33 Printer
36 Package bag
36A Small bag
40 Filling unit
50 Nozzle
52 Nozzle main body
53 Shutter part
54 Insertion guidance piece
54a Distal end part
56 Posture adjustment part
56a Distal end part
58 Closing guidance piece
60 Sealing device
61 Vertical seal part
62 Heater block
63 Pressure receiving block
62a, 63a Vertical part
62b, 63b Parallel part
62c Vertical tooth receiving part
64 Actuator
66, 73, 79 Motor
72 Roller
76 Cutter
77 Conveyor
H Packaging paper
H1 Upper opening
Ha Folded part
S Welded part
Y, Y1, Y2, Y3 Drug

1. A drug supply apparatus that packages a drug with packaging paper that is conveyed from an upstream side to a downstream side, the packaging paper being folded in half with an opening on an upper side, the drug supply apparatus comprising:
a nozzle that dispenses the drug into the packaging paper, the packaging paper including a sealed part where the packaging paper is sealed on the downstream side, wherein
the nozzle includes:
an insertion guidance piece that protrudes downward and positions a folded part of a lower end of the packaging paper in a state of being inserted in the packaging paper from the opening on the upper side, and
a posture adjustment part that guides to inside of the packaging paper the drug to be dispensed, and causes the drug to stand while shifting the drug toward the sealed part side in the packaging paper, the posture adjustment part being provided on the downstream side of the insertion guidance piece.

2. The drug supply apparatus according to claim 1, wherein
the posture adjustment part causes the drug to stand in a posture inclined to the downstream side with respect to a vertical direction.

3. The drug supply apparatus according to claim 1, wherein
a length in a conveyance direction from an end part of the posture adjustment part on the downstream side to the sealed part is 15.2 mm or more.

4. The drug supply apparatus according to claim 1, wherein
the posture adjustment part is provided integrally with the insertion guidance piece.

5. The drug supply apparatus according to claim 1, wherein
the posture adjustment part is detachably provided to the insertion guidance piece.
